(19) United States
(12) Patent Application Publication
(10) Pub. No.: US 2017/0134139 A1
(43) Pub. Date: May 11, 2017

(54) METHOD AND APPARATUS FOR FAST ACCESS IN COMMUNICATION SYSTEM

(71) Applicant: ELECTRONICS AND TELECOMMUNICATIONS RESEARCH INSTITUTE, Daejeon (KR)

(72) Inventors: Seungkwon CHO, Daejeon (KR); Yu Ro LEE, Daejeon (KR); Soojung JUNG, Daejeon (KR); Anseok LEE, Daejeon (KR); Sung Cheol CHANG, Daejeon (KR)

(73) Assignee: ELECTRONICS AND TELECOMMUNICATIONS RESEARCH INSTITUTE, Daejeon (KR)

(21) Appl. No.: 15/343,891

(22) Filed: Nov. 4, 2016

(30) Foreign Application Priority Data
Nov. 6, 2015 (KR) 10-2015-0156143
Jan. 19, 2016 (KR) 10-2016-0006408
Aug. 5, 2016 (KR) 10-2016-0100149

(51) Int. Cl. H04L 5/00; H04W 72/04

(52) U.S. Cl. CPC H04L 5/0055; H04W 72/0446; H04W 88/08

(57) ABSTRACT

Disclosed is a base station that grants the same shared resource to a plurality of terminals, identifies a terminal transmitting uplink data in the same transmission time interval (TTI), when each of the plurality of terminals starts an initial transmission of the uplink data using the shared resource by distributed scheduling, allows each of the plurality of terminals to recognize not-acknowledgement (NACK) as a response signal to the uplink data if the number of terminals transmitting the uplink data is equal to or more than 1; and grants a contention-free resource as a retransmission resource to each of at least some terminals among the first number of terminals transmitting data that fail to receive among the identified terminals.

### CROSS-REFERENCE TO RELATED APPLICATION

This application claims priority to and the benefit of Korean Patent Application Nos. 10-2015-0156143, 10-2016-0006408, and 10-2016-0100149 filed in the Korean Intellectual Property Office on Nov. 6, 2015, Jan. 19, 2016, and Aug. 5, 2016, the entire contents of which are incorporated herein by reference.

### BACKGROUND OF THE INVENTION

(a) Field of the Invention

The present invention relates to a method and an apparatus for fast access in a communication system, and more particularly, to a technology of transmitting data to a base station using radio resources shared by distributed scheduling of a plurality of terminals, not by centralized scheduling of the base station, when the terminals can share the same radio resources in a communication system using the radio resources.

(b) Description of the Related Art

In a communication system configured of terminals and a base station, upon an uplink transmission that transmits data from the terminals to the base station and a downlink transmission that transmits data from the base station to the terminals, a reduction in latency taken from time when data reach a transmit buffer of the terminal or the base station to time when a final data transmission to the other base station or terminals is successfully completed is considered as a core matter of a future communication technology.

According to a typical method of managing, by a base station, radio resources, in the case of the downlink transmission, the base station may immediately appreciate that the transmitted data reach the transmit buffer of the base station. Therefore, the base station may immediately grant resources for the reached downlink data transmission. In contrast, in the case of the uplink transmission, the base station may not immediately appreciate that the transmitted data reach the transmit buffer of the terminal. Therefore, when the transmitted data are reached, the terminal requests an uplink resource to the base station and the base station receiving the uplink resource request grants the uplink resource for the request to the corresponding terminal, such that the terminal may use the uplink resource to transmit data.

The above-mentioned method using the centralized scheduling of the base station has a disadvantage of increasing latency due to a plurality of signal exchange procedures between the terminals and the base station and the accompanied signal processing. To overcome the disadvantage, a technology of transmitting data one-shot without the signal exchange like the request-grant between the terminals and the base station by the distributed scheduling of the terminals has been considered to be important.

For the terminal to transmit data one-shot, the base station previously grants the radio resources to the terminal, which is called pre-scheduling. According to the pre-scheduling, the base station grants resources in advance in the state in which it does not know whether the terminal actually uses the pre-scheduled resource. Therefore, when the pre-scheduled radio resource is not used since the terminal does not have data to transmit, the pre-scheduled radio resource wastes. Therefore, when a data transmission load of the terminal is much lower than the amount of pre-scheduled resource, the waste of resources is very severe. To reduce the latency while overcoming the waste of resources, technologies of transmitting data using shared resources according to distributed scheduling of a plurality of terminals while the terminals share the same radio resources have been researched a lot.

The technologies of allowing several terminals to share resources and each terminal to independently transmit data depending on distributed scheduling may not avoid a collision of the data transmitted by the terminals.

Most of the existing technologies perform a retransmission by performing backoff when the collision occurs. The backoff essentially spreads an instantaneous high load over a time domain to prevent a collision from occurring upon the retransmission after the collision. Therefore, increasing the latency up to the finally successful data transmission including the retransmission may not be avoided. Therefore, efforts have been made to find out other methods other than the method of using backoff. One of the methods, a contention-free retransmission based on UE identification method of identifying colliding terminals when the collision occurs and granting in a centralized manner, by a base station, contention-free dedicated resources to each of the identified terminals to perform a retransmission is emerging.

However, the contention-free retransmission based on user equipment (UE) identification methods that are emerging recently do not consider a method of efficiently using resources, or the like. Further, the methods that are emerging recently may not achieve an original object to reduce latency since they focus on reducing the time taken for a terminal to successfully transmit data upon the collision even though they may more reduce the latency.

### SUMMARY OF THE INVENTION

The present invention has been made in an effort to provide a method and an apparatus for fast access in a communication system having advantages of efficiently using shared resources in a contention-free retransmission based on user equipment (UE) identification method and maximally reducing latency taken for a terminal to successfully transmit data.

An exemplary embodiment of the present invention provides a method for fast access of a terminal in a base station. The method includes: granting the same shared resource to a plurality of terminals; identifying a terminal transmitting uplink data in the same transmission time interval (TTI), when each of the plurality of terminals starts an initial transmission of the uplink data using the shared resource in the same TTI by distributed scheduling; recognizing, by each of the plurality of terminals, not-acknowledgement (NACK) as a response signal to the uplink data if the number of terminals transmitting the uplink data estimated by the identification is equal to or more than 1; and granting a contention-free resource as a retransmission resource to each of at least some terminals among the first number of terminals transmitting data that fail to receive among the identified terminals.

The recognizing of the NACK as the response signal may include transmitting the NACK to the plurality of terminals.

The recognizing of the NACK as the response signal may include transmitting neither the ACK nor the NACK.

The method may further include: transmitting a new transmission resource grant signal used to inform the second number of terminals transmitting the uplink data that are successfully received among the identified terminals of the success of reception.

The granting of the contention-free resource as the retransmission resource may include granting the contention-free resource to some of the first number of terminals, and the method may further include receiving retransmitted data using the same resource used for the initial transmission from the rest terminals other than some of the first number of terminals.

The method may further include: combining and decoding the retransmitted uplink data when each of the at least some terminals performs a retransmission procedure of the uplink data at least twice using the contention-free resource.

The method may further include: receiving the retransmitted data from each of the first number of terminals using the contention-free resource, and combining the retransmitted data with the initial transmission data received from each of the first number of terminals and decoding the combined data.

The granting of the shared resource may include: transmitting a period of the shared resource and an identifier used to grant the shared resource to the plurality of terminals before an activation time of the shared resource; and determining a size and a position of the shared resource at the activation time and transmitting the shared resource to the plurality of terminals, in which the identifier used to grant the shared resource is differently assigned to each terminal within a cell.

The granting of the shared resource may further include determining a modulation and coding scheme (MSC) of the plurality of terminals so that at least some of the plurality of terminals have different MCSs.

The method may further include: instructing deactivation of the shared resource to at least one of the plurality of terminals, in which the shared resource may not be granted to other terminals until the number of terminals using the shared resource is 0.

The method may further include: instructing the deactivation of the shared resource to the at least one terminal when a deactivation signal indicating a deactivation request is successfully received once from at least one of the plurality of terminals through the shared resource.

The deactivation signal may include a zero service data unit (SDU) or a zero buffer status report (BSR).

Another exemplary embodiment of the present invention provides a method for fast access of terminal in a base station. The method includes: granting the same shared resource to a plurality of terminals; identifying a terminal transmitting uplink data in the same transmission time interval (TTI), when each of the plurality of terminals starts an initial transmission of the uplink data using the shared resource in the same TTI by distributed scheduling; transmitting acknowledgement (ACK) as a response signal to the uplink data to the plurality of terminals if the number of terminals transmitting the uplink data estimated by the identification is equal to or more than 1; and granting a contention-free resource as a retransmission resource to each of at least some terminals among the first number of terminals transmitting data that fail to receive among the identified terminals.

The granting of the contention-free resource may include granting the contention-free resource to the first number of terminals at the same time or different time.

The method may further include: receiving the retransmitted data from each of the first number of terminals using the contention-free resource, and combining the retransmitted data with the initial transmission data received from each of the first number of terminals and decoding the combined data.

The method may further include: combining and decoding the retransmitted uplink data when each of the at least some terminals performs a retransmission procedure of the uplink data at least twice using the contention-free resource.

Yet another embodiment of the present invention provides an apparatus for fast access of a terminal in a base station. The apparatus includes a transceiver and a processor. The transceiver may communicate with a plurality of terminals to which the same shared resource is granted. The processor may identify a terminal transmitting uplink data in the same transmission time interval (TTI) when each of the plurality of terminals starts an initial transmission of the uplink data using the shared resource in the same TTI by distributed scheduling, and allow the plurality of terminals to recognize not-acknowledgement (NACK) or acknowledgement (ACK) as a response signal to the uplink data if the number of terminals transmitting the uplink data estimated by the identification is equal to or more than 1, and grant a contention-free resource as a retransmission resource to each of at least some terminals among the first number of terminals transmitting the uplink data that fail to receive among the identified terminals.

The processor may generate the ACK or the NACK as the response signal to the initial transmission if the number of terminals is equal to or more than 1 and transmit the ACK or the NACK to the plurality of terminals through the transceiver.

The processor may transmit neither the ACK nor the NACK, and the plurality of terminals may recognize the NACK if the response signal is not received.

The processor may grant a new transmission resource used to inform each of the second number of terminals transmitting the uplink data that are successfully received among the identified terminals of the success of reception and transmit a new transmission resource grant signal through the transceiver.

### BRIEF DESCRIPTION OF THE DRAWINGS

FIG. 1 is a diagram illustrating an example of a configuration of shared resources according to an exemplary embodiment of the present invention.

FIG. 2 is a diagram illustrating an example of granting shared resources according to an exemplary embodiment of the present invention.

FIG. 3 is a diagram illustrating an example of an access method of maximally reducing latency taken for shared terminals to successfully transmit data in a contention-free retransmission based on user equipment identification method according to an exemplary embodiment of the present invention.

FIG. 4 is a diagram illustrating another example of an access method of maximally reducing latency taken for shared terminals to successfully transmit data in a contention-free retransmission based on user equipment identification method according to an exemplary embodiment of the present invention.

FIG. 5 is a diagram illustrating still another example of an access method of maximally reducing latency taken for shared terminals to successfully transmit data in a contention-free retransmission based on user equipment identification method according to an exemplary embodiment of the present invention.

FIG. 6 is a diagram illustrating an apparatus for fast access according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Throughout the present specification and claims, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (a femto base station (femto BS), a home node B (HNB), a home eNodeB (HeNB), a pico base station (pico BS), a metro base station (metro BS), a micro base station (micro BS), and the like), and the like and may also include all or some of the functions of the ABS, the HR-BS, the node B, the eNodeB, the AP, the RAS, the BTS, the MMR-BS, the RS, the RN, the ARS, the HR-RS, the small base stations, and the like.

An exemplary embodiment of the present invention considers an uplink transmission of a communication system configured of terminals and a base station. The communication system may also have a remote radio head (RRH) in a physical configuration of a system. Further, the communication system to which the exemplary embodiment of the present invention is applied may use a frequency division duplex (FDD) scheme, a time division duplex (TDD) scheme, and both of them.

Hereinafter, a method and an apparatus for fast access in a communication system according to an exemplary embodiment of the present invention will be described in detail with reference to the accompanying drawings.

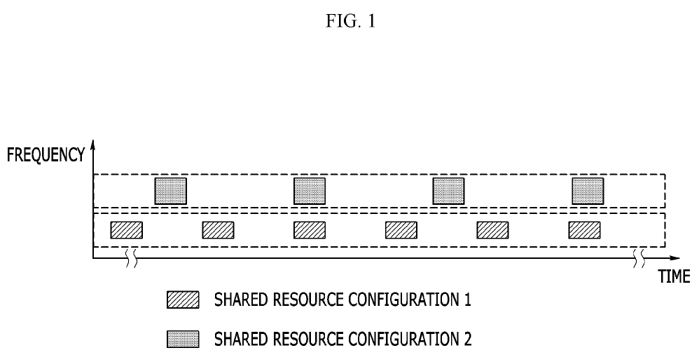

FIG. 1 is a diagram illustrating an example of a configuration of shared resources according to an exemplary embodiment of the present invention.

Referring to FIG. 1, one shared resource configuration defines a period of resources spaced at a predetermined time interval and a size of resources. Therefore, when the shared resource configurations are different, the period of resources and the size of resources may be different. For example, as illustrated in FIG. 1, a shared resource configuration 1 has a period shorter and a size smaller than a shared resource configuration 2.

The exemplary embodiment of the present invention defines a set of terminals sharing one shared resource configuration as a set of shared terminals.

Each terminal forming the set of the shared terminals may be dynamically included in the set of the shared terminals and may be dynamically ruled out from the set of the shared terminals.

Any one terminal is granted the shared resources corresponding to the any shared resource configuration from the base station. In the case of long term evolution (LTE) based on a 3GPP standard, the base station may use semi-persistent scheduling (SPS) to grant the shared resources.

In a method for granting shared resources considered in the exemplary embodiment of the present invention, the SPS is an SPS having characteristics that need not transmit any signal as well as a zero service data unit (SDU) (data consisting of a padded protocol data unit (PDU) or padding bits without actual data) when a terminal does not have data to be transmitted in an uplink. Due to the characteristics, the present invention is based on the fact that a plurality of terminals may share the same resources granted by the SPS.

Further, the method for granting shared resources according to the exemplary embodiment of the present invention may grant the dynamic resources having the above-mentioned characteristics as well as may grant resources by the SPS. The dynamic resource grant is a method for allowing a base station to inform a terminal of resource grant every transmit time interval (TTI) at which resources are granted.

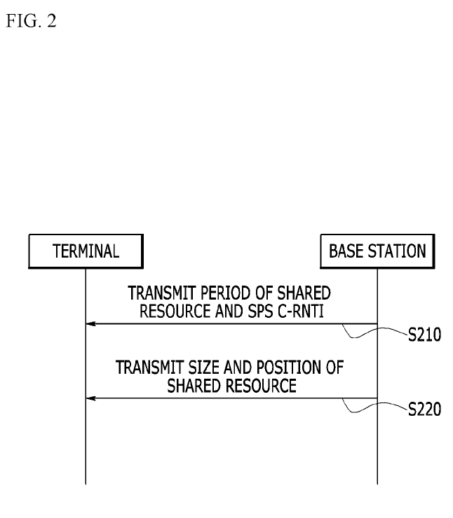

FIG. 2 is a diagram illustrating an example of granting shared resources according to an exemplary embodiment of the present invention.

Referring to FIG. 2, in the case of the SPS in the 3GPP, first, the base station informs a terminal of a period of shared resources and an identifier (SPS C-RNTI) used to grant the shared resources by a radio resource control (RRC) message before activation time when actual shared resources may be used (S210). Next, the base station determines the amount and position of actual resources at the activation time and informs the terminal of the determined amount and position (S220), thereby granting the actual shared resources to the terminal.

According to the exemplary embodiment of the present invention, the shared resources are granted like the SPS scheme in the 3GPP (S210 and S220). However, according to the exemplary embodiment of the present invention, to efficiently use the shared resources, in assigning the identifier (SPS C-RNTI) used to grant the shared resources to the terminal by the RRC message, the base station assigns different unique identifiers (that is, dedicated SPS C-RNTI) to each terminal within a cell.

As such, the exemplary embodiment of the present invention provides methods for efficiently using shared resources by using a unique SPS C-RNTI for each terminal within a cell.

As one of the methods for efficiently using shared resources, the base station may allow at least some terminals within a set of shared terminals following one shared resource configuration to have different modulation and coding schemes (MCSs) when activating the terminals.

As described above, each terminal within the set of shared terminals following the one shared resource configuration has a period and a size of the same resource. However, according to the method, each terminal may have different MCSs depending on the circumstances of each terminal. In this case, the actual amount of data that each terminal may transmit using the shared resources in any TTI is changed depending on the MCS.

If the set of shared terminals is configured only of the terminals having the same MCS, the base station needs to have the same number of shared resource configurations as the kind of MCSs, which causes resource inefficiency. For example, when a BPSK terminal is one, a QPSK terminal is one, and a 16 QAM terminal is one, according to the exemplary embodiment of the present invention, if each terminal within the set of shared terminals is configured to have different MCSs, one set of shared terminals is required, but if not, three sets of shared terminals are required. When the amount of resources required for each set of shared terminals is the same and transmission amount of each terminal are small, three sets of shared terminals cause a huge waste of resources.

According to another method, the base station uses reactivation for each terminal to change the set of shared terminals to which a specific terminal belongs to other sets of shared terminals.

The reactivation is a method for changing, by any terminal, designated parameters upon activation by using the SPS C-RNTI used by the corresponding terminal in the 3GPP standard. According to the exemplary embodiment of the present invention, the terminal within the cell may use different SPS C-RNTIs, and therefore the reactivation for each terminal may be made.

The exemplary embodiment of the present invention may also use the reactivation to change, the set of shared terminals to which a terminal belongs to other sets of shared terminals. For example, the base station operates a plurality of shared resource configurations, in which when the terminal within the set of shared terminals using any one shared resource configuration is only one and a terminal may be added to other sets of shared terminals, the corresponding terminal is reactivated using the amount and position of resources that are used by the other sets of shared terminals depending on the determination of the base station and thus the number of terminals included in the set of shared terminals using the shared resource configuration used by the corresponding terminal is set to be 0, such that the base station makes the resources granted to the corresponding shared resource configuration into a state in which the resources may be used for other terminals, thereby increasing the resource efficiency.

According to another method, the base station may change the MCS of the specific terminal using the reactivation for each terminal.

When any terminal within the set of shared terminals moves or the optimal MCS is changed due to the change in channel conditions, only the corresponding terminal is reactivated by other MCSs to reduce the unnecessary retransmission occurring by using the MCS that is not optimized, thereby increasing the resource efficiency.

As another method, the base station may use deactivation for each terminal to release the use of the shared resources for each terminal.

The deactivation is a method for releasing shared resources, that is, allowing a terminal not to use shared resources any more. Generally, each terminal within the set of shared terminals may be different from the point which a fast access method using the shared resources provided by the exemplary embodiment of the present invention is not required.

When the terminals within the set of shared terminals no more require a fast access method using the shared resources provided by the exemplary embodiment of the present invention, each terminal may be generally different.

In this case, deactivating each terminal at the moment that a necessity for the shared resources for each terminal within each set of shared terminals disappears may more increase the resource efficiency than the case when all terminals within the set of shared terminals wait for up to the moment that a necessity for the shared resources disappears.

In the case of the SPS of the 3GPP, the shared resources may be released by three methods in the case of the LTE based on the 3GPP standard. First, in the case of an explicit release or explicit deactivation method, the base station explicitly deactivates the use of shared resources to the terminal by using the SPS C-RNTI through a physical downlink control channel (PDCCH). Another method is implicit release or implicit deactivation. In the case of the implicit deactivation, the terminal transmits the zero SDU to the base station for a predetermined period, thereby deactivating the use of the shared resources. A third method releases the shared resource configuration of the corresponding terminal by the RRC message.

Unlike the SPS of the existing 3GPP standard allowing one terminal to exclusively use the resources granted by the SPS, the exemplary embodiment of the present invention assumes that the plurality of terminals share the resources granted by the SPS, and therefore provides the method for releasing shared resources by using each of the three methods for releasing shared resources as follows.

Preferentially, even though the exemplary embodiment of the present invention releases the resources granted to one terminal by the SPS based on any of the three methods unlike the existing 3GPP standard, the corresponding terminal considers that the corresponding resource is released and thus no more uses the corresponding resource, but the base station determines that the corresponding resource is continuously used unlike the existing 3GPP standard when the number of terminals sharing the corresponding resource is not 0, such that other terminals that are not included in the set of shared terminals do not use the corresponding resource.

Further, when the terminal transmits the zero SDU in the uplink for a predetermined time depending on the implicit deactivation, it is highly likely to collide with data transmitted by other terminals, and therefore the exemplary embodiment of the present invention may provide a method different from the existing 3GPP standard. In the case of the implicit deactivation method provided in the exemplary embodiment of the present invention, when the terminal successfully transmits once the implicit deactivation signal representing a deactivation request through the shared resources granted by the SPS, it is considered that the terminal transmits the implicit deactivation signal to the base station.

The exemplary embodiment of the present invention may use the zero SDU or a zero buffer status report (BSR) as the implicit deactivation signal transmitted once. The zero BSR is a message representing all the buffer statuses as 0, in a BSR message that is a message representing a status of a terminal transmit buffer.

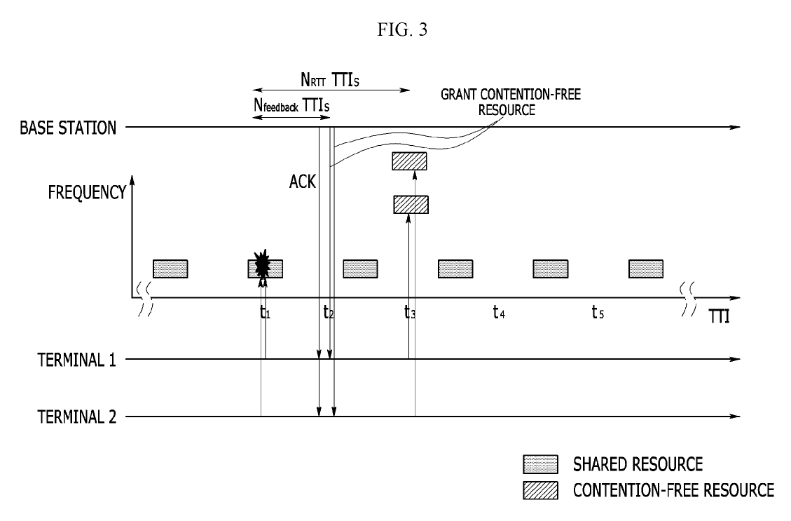

FIG. 3 is a diagram illustrating an example of an access method of maximally reducing latency taken for shared terminals to successfully transmit data in a contention-free retransmission based on user equipment identification method according to an exemplary embodiment of the present invention.

As described above, the contention-free retransmission based on UE identification method according to the exemplary embodiment is a method for allowing a plurality of terminals to share resources using shared resources and each terminal to independently transmit data by distributed scheduling, identifying colliding terminals to allow a base station to concentratedly grant dedicated resources without collision to each of the identified terminals, thereby performing a retransmission.

For simple illustration, in FIG. 3, it is assumed that two terminals, that is, a terminal 1 and a terminal 2 share resources.

An operation according to the exemplary embodiment of the present invention will be described below with reference to FIG. 3. The terminal 1 and the terminal 2 are terminals that are included in the set of the shared terminals using the same shared resource configuration. The terminal 1 and the terminal 2 may start to independently transmit uplink data by the distributed scheduling.

If only one terminal starts to transmit data at any time t1, the transmitted data do not have a special collision. In this case, when the base station successfully receives the corresponding data, the base station transmits acknowledgement (ACK) to the terminal at a promised time (t2=t1+N_{feedback}) to finish an operation depending on the data transmission of the terminal. Here, units of each time t1 to t5 illustrated in FIG. 3 may be TTI.

The ACK signal transmitted from the base station to the terminal is a signal that may be commonly received by all the terminals belonging to the set of shared terminals sharing the same shared resource configuration. Even though the base station transmits only one ACK signal at time t2, the terminals transmitting data at time t1 consider the ACK signal transmitted by the base station at time t2 to be transmitted to each of the terminals and receive the ACK signal.

However, as illustrated in FIG. 3, if the terminal 1 and the terminal 2 start to simultaneously transmit data at time t1, a collision may occur and the base station may not successfully receive all the data transmitted by the terminal 1 and the terminal 2.

According to the exemplary embodiment of the present invention, it is premised that the signal transmitted by the terminal includes a means capable of identifying the terminal transmitting the signal. For example, when each terminal uses different demodulation reference signals (DMRSs), the base station may identify each of the transmit terminals even if the collision occurs. According to the exemplary embodiment of the present invention, it is premised that the base station has the following two features in connection with whether the base station receives the means capable of identifying the transmit terminal and whether the base station receives the transmitted data of the terminal.

As the first feature, regardless of the collision or not, the base station may estimate the number of transmit terminals at the same TTI based on the means capable of identifying the transmit terminal. If the number of transmit terminals estimated by the base station is set to be N_{EstimatedTxUeNum} and the actual number of transmit terminals at the same TTI is set to be N_{TrueUeNum}, the relationship between the actual number of terminals and the estimated number of terminals satisfies the relationship of the following Equation 1.

N_{EstimatedTxUeNum}≦N_{TrueUeNum} and N_{EstimatedTxUeNum}≧0 and N_{TrueUeNum}≧0 (Equation 1)

As the second feature, the number of data successfully received by the base station, denoted as N_{RxDataNum}, satisfies the relationship of the following Equation 2.

N_{RxDataNum}≦N_{EstimatedTxUeNum} and N_{RxDataNum}≧0 (Equation 2)

The Equation 3 may be derived from the above Equations 1 and 2.

N_{TrueUeNum}≧N_{EstimatedTxUeNum}≧N_{RxDataNum}≧0 (Equation 3)

According to the exemplary embodiment of the present invention, in FIG. 3, when the collision occurs, the base station feeds back the ACK in the downlink only when N_{EstimatedTxUeNum}>0 at a promised time t2 and in other cases, nothing is transmitted.

Further, the base station dynamically grants contention-free resources, not the shared resources, as retransmission resources of each terminal to a total of identified N_{EstimatedTxUeNum}−N_{RxDataNum} terminals, respectively, transmitting data that fail to receive by using the means capable of identifying the transmit terminals at the promised time t2.

In FIG. 3, if N_{EstimatedTxUeNum}=2 and N_{RxDataNum}=0, the base station feedbacks ACK in the downlink since N_{EstimatedTxUeNum}>0 at time t2. Simultaneously, the base station grants the uplink contention-free resources which will be used to each of the terminal 1 and the terminal 2 at time t3=t1+N_{RTT} to instruct the performance of the retransmission. The terminal 1 and the terminal 2 each perform the retransmission using the dedicated contention-free resources granted at the time t3.

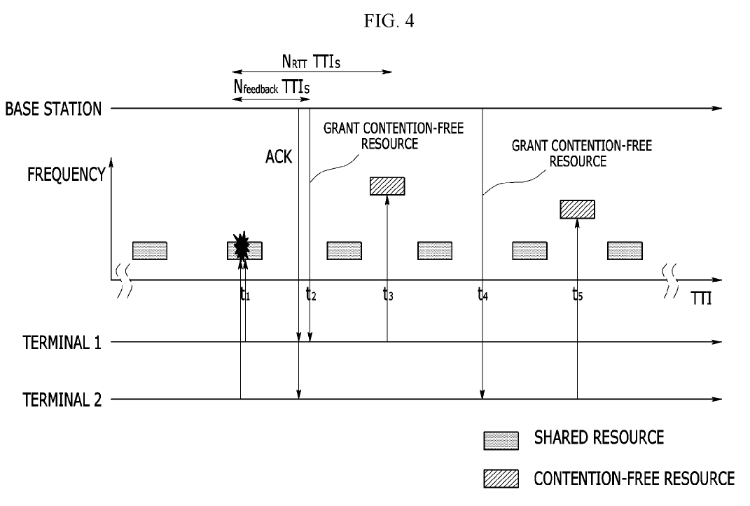

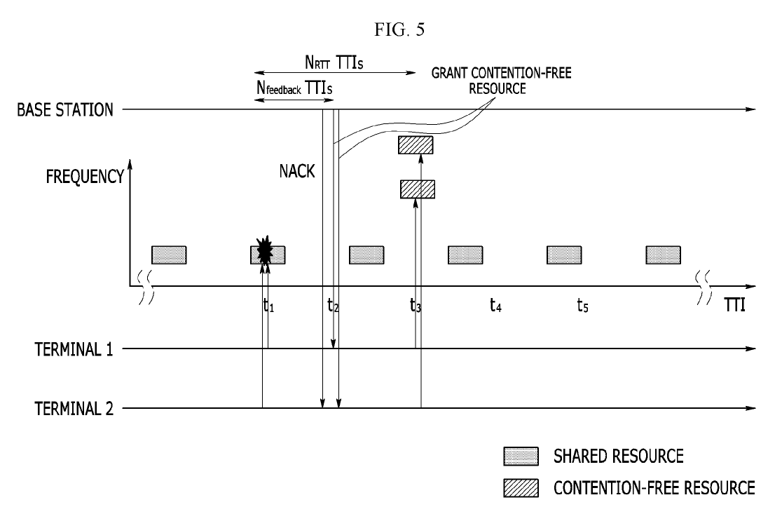

Meanwhile, FIG. 3 illustrates that the ACK transmission and the contention-free resource grant are performed at different time, which is due to the restriction of expression on the drawings, and therefore it is not to be understood by the drawings that the ACK transmission and the contention-free resource grant are performed at different time. Hereinafter, even in the FIGS. 4 and 5, these matters may be identically applied.

FIG. 4 is a diagram illustrating another example of an access method of maximally reducing latency taken for shared terminals to successfully transmit data in a contention-free retransmission based on user equipment identification method according to an exemplary embodiment of the present invention.

Like FIG. 3, FIG. 4 is a diagram illustrating an example in which the base station allows a total of N_{EstimatedTxUeNum}−N_{RxDataNum} terminals transmitting data that fail to receive not to perform the retransmission at the same time but allows some or all of the N_{EstimatedTxUeNum}−N_{RxDataNum} terminals to perform the retransmission at wanted time.

Referring to FIG. 4, like FIG. 3, if N_{EstimatedTxUeNum}=2 and N_{RxDataNum}=0, the base station feedbacks ACK in the downlink since N_{EstimatedTxUeNum}>0 at time t2=t1+N_{feedback}. Simultaneously, the base station grants uplink contention-free resources for transmission at the time t3 only to the terminal 1, unlike FIG. 2. The terminal 1 performs the retransmission using the dedicated contention-free resources granted at the time t3.

Meanwhile, the terminal 2 is not granted the resources for retransmission at time t2=t1+N_{feedback} but simultaneously receives the ACK like the terminal 1, and therefore the terminal 2 does not delete data that fail to transmit in its own hybrid ARQ (HARQ) buffer. Then, if the base station grants the uplink contention-free resources to the terminal 2 for retransmission at time t4=t1+N_{RTT}+N_{feedback}, the terminal 2 performs the retransmission at time t5=t1+2*N_{RTT}. * represents a multiplication.

Like FIG. 4, the case in which the base station makes the retransmission time of the terminal 1 and terminal 2 different may include, for example, the case in which the number of terminals that need to perform the retransmission at any TTI or the amount of required retransmission resources exceeds the number of terminals or the amount of resources that may be supported at the corresponding TTI.

According to the exemplary embodiment of the present invention, the terminal 1 and the terminal 2 are operated using the contention-free resources, not the shared resources, depending on a normal uplink synchronous HARQ procedure after including the retransmission other than the initial transmission.

According to the exemplary embodiment of the present invention, the terminal 1 and the terminal 2 are operated using the contention-free resources depending on a normal uplink HARQ operation from the retransmission, and therefore the base station may combine the retransmitted data other than the initial transmission for each terminal to reduce the retransmission frequency. For example, when the base station does not receive the data transmitted by the terminal 1 at the time t3 and performs the retransmission (subsequent retransmission due to the failure of retransmission) at the time t5, the base station combines, at the time t5, the signal that fails to receive at the time t3 with the signal that is received at the time t5 and decodes the combined signal to increase the probability that data will be successfully received at the time t5, thereby avoiding the latency due to the additional retransmission.

Further, the exemplary embodiment of the present invention also includes a method for including and combining initial transmission data upon HARQ combination. That is, if the base station operates the shared resources to lower the collision probability in the shared resources, the base station increases the possibility to generate a combining gain when combining the initial transmission that fails to receive with the subsequent retransmission.

The exemplary embodiment of the present invention also provides a method for transmitting not-acknowledgement (NACK) in addition to the method for transmitting, by a base station, ACK to a downlink. That is, the base station may transmit the NACK in the downlink at the time t2 when it transmits feedback in the downlink.

According to the exemplary embodiment of the present invention, the method for feedbacking, by a base station, NACK may include a method for transmitting, by a base station, NACK to a terminal at time t2 and a method for transmitting neither ACK nor NACK, when the terminal transmits data in the uplink at the time t1. When the base station does not transmit the ACK or the NACK at the time t2, since the terminal recognizes the NACK, both of the methods may be a substantially effective method for transmitting NACK to a terminal.

Therefore, in the method for feedbacking NACK, if the method for substantially feedbacking NACK is used, only when N_{EstimatedTxUeNum}>0, the base station feeds back the NACK in the downlink and in other cases, nothing may be transmitted.

If in the method for feedbacking NACK, a method for not transmitting any signal is used, the base station does not always transmit any signal regardless of the number N_{EstimatedTxUeNum}.

The NACK transmitted from the base station to the terminal is a signal that may be commonly received by all the terminals belonging to the set of shared terminals sharing the same shared resource configuration. Even though the base station transmits only one NACK at the time t2, the terminals transmitting data at the time t1 consider the NACK transmitted by the base station at the time t2 to be owned by each of the terminals and receive the NACK.

FIG. 5 is a diagram illustrating another example of an access method of maximally reducing latency taken for shared terminals to successfully transmit data in a contention-free retransmission based on user equipment identification method according to an exemplary embodiment of the present invention.

As illustrated in FIG. 5, if the terminal 1 and the terminal 2 simultaneously transmit data at the time t1 and thus the collision occurs, the base station transmits the NACK in the downlink at the time t2. In this case, the base station uses the means capable of identifying the transmit terminal simultaneously with transmitting the NACK at the time t2 to perform the retransmission to each of the identified transmit terminals using the transmission resources without collision at the time t3, thereby granting the contention-free resources. The operation is like transmitting, by the base station, an uplink grant to each of the terminals through a physical downlink control channel (PDCCH) simultaneously with feedbacking the NACK through a physical HARQ indicator channel (PHICH) at the time t2, in the case of the 3GPP LTE.

A method for feedbacking, by the base station according to the exemplary embodiment of the present invention, NACK in a downlink at time t2 when the feedback is transmitted in the downlink is generalized and described as follows.

The base station transmits the NACK in the downlink at the time t2. In this case, the NACK is transmitted and at the same time, the dedicated contention-free resources are granted to perform the retransmission to each of the N_{EstimatedTxUeNum}−N_{RxDataNum} terminals (i.e., the terminal that is identified by the base station but does not receive data) using the transmission resources without collision at the time t3. Further, the base station grants resources for new transmission at the time t2 to inform the N_{RxDataNum} terminals (i.e., terminals that are identified by the base station and successfully receive data) that the base station successfully receives data.

When the method for feedbacking, by a base station, NACK to a downlink at time t2 is applied to the 3GPP LTE standard, the base station transmits the uplink grant for retransmission including information on some resources of a contention-free physical uplink shared channel (PUSCH) that are not shared to each of the N_{EstimatedTxUeNum}−N_{RxDataNum} terminals that are identified but fail to receive data simultaneously with transmitting the NACK to the physical HARQ indicator channel (PHICH) at the time t2. Further, the base station transmits the uplink grant for new transmission to each of the N_{RxDataNum} terminals that are identified and succeed to receive data. The uplink grant for retransmission and the uplink grant for new transmission may be differentiated by a new data indicator (NDI). In the uplink grant for retransmission, the NDI is not toggled within the uplink grant and in the uplink grant for new transmission, the NDI is toggled within the uplink grant. That is, the NDI within the uplink grant for retransmission is transmitted in the same bit state as an NDI bit state within a previous uplink grant and the NDI within the uplink grant for retransmission is transmitted in a bit state different from the NDI bit state within the previous uplink grant.

Therefore, to inform N_{RxDataNum} terminals (i.e., terminals that are identified by the base station and successfully receive data) that the base station successfully receives data at the time t2, N_{RxDataNum} uplink grants are transmitted to each of the N_{RxDataNum} terminals while the NDI is toggled, such that the resources for new transmission may be dynamically granted to the N_{RxDataNum} terminals. In this case, the resources for new transmission dynamically granted are any resource within the PUSCH and some resources within the same PUSCH are commonly granted to all of the N_{RxDataNum} terminals or some or all of the N_{RxDataNum} terminals may each be granted some resources within different PUSCHs.

Further, according to the exemplary embodiment of the present invention, the base station may grant the dedicated contention-free resources to some of the N_{EstimatedTxUeNum}−N_{RxDataNum} terminals that fail to receive data at the time t2, that is, only J terminals. However, 0≦J<(N_{EstimatedTxUeNum+}−N_{RxDataNum}). In this case, the J terminals among the terminals that are identified but do not successfully receive data of the identified terminals at the time t1 are granted the dedicated contention-free resources at the time t2 and perform the retransmission using the contention-free resources at the time t3. The rest N_{EstimatedTxUeNum}−N_{RxDataNum}−J terminals perform the retransmission at the time t3 without special grant information at the time t2 using the size of the same resources and the position of resources that are used at the time t1 by a non-adaptive synchronous HARQ operation of the uplink. In this case, the N_{EstimatedTxUeNum}−N_{RxDataNum}−J terminals perform the retransmission using the shared resources having the possibility of collision at the time t3 when there are the shared resources belonging to the same shared resource configuration used at the time t1.

One example in which the methods are required is the case in which it is difficult to grant the contention-free resources to all the N_{EstimatedTxUeNum}−N_{RxDataNum} terminals at the time t2. For example, in the case of the 3GPP LTE, when it is determined that the resources of the PDCCH are insufficient at the time t2 or it is determined at the time t2 that the resources of the PUSCH are insufficient at the time t3, a method for granting dedicated contention-free resources to only some of the N_{EstimatedTxUeNum}−N_{RxDataNum} terminals is required.

The method for feedbacking NACK to a downlink at time t2 when the base station transmits the feedback in the downlink has an advantage of reducing the latency when there are the terminals that transmit data at the time t1 but are not identified by the base station, that is, when N_{TrueUeNum}−N_{EstimatedTxUeNum}>0.

The reason is that when the base station transmits the ACK at the time t2, the N_{TrueUeNum}−N_{EstimatedTxUeNum} terminals substantially fail to data but the base station feeds back the ACK, and therefore the N_{TrueUeNum}−N_{EstimatedTxUeNum} terminals inform that their own data are successfully transmitted. The base station does not instruct the N_{TrueUeNum}−N_{EstimatedTxUeNum} terminals to perform the separate retransmission since data are not received and terminals are not identified. Therefore, it is sensed that the omission of the data transmitted by the N_{TrueUeNum}−N_{EstimatedTxUeNum} terminals occurs in an upper layer after long latency lapses and the retransmission is performed at that time, such that the latency is very large. Here, one example of the upper layer may be a retransmission of a radio link control (RLC) layer, a retransmission of a transmission control protocol (TCP), or the like of the 3GPP LTE.

According to the exemplary embodiment of the present invention, the HARQ combination by the method for feedbacking, by a base station, NACK in a downlink at time t2 may be applied to the terminals that are granted the contention-free resources at the time t2 and performs the retransmission using the contention-free resources from the time t3. The terminals performing the retransmission using the contention-free resources from the time t3 are operated using the contention-free resources depending on the normal uplink HARQ operation from the retransmission, and therefore the base station combines the retransmitted data other than the initial transmission for each terminal, thereby reducing the retransmission frequency. For example, when the base station does not receive the data retransmitted by the terminal using the contention-free resources at the time t3 and therefore the terminal performs the retransmission (subsequent retransmission due to the failure of retransmission) at the time t5, the base station combines, at the time t5, the signal that fails to receive at the time t3 with the signal that is received at the time t5 and decodes the combined signal to increase the probability that data will be successfully received at the time t5, thereby avoiding the latency due to the additional retransmission.

Further, the HARQ combination by the method for feedbacking, by a base station, NACK to a downlink at the time t2 also includes the method for combining initial transmission data.

As described above, both of the method for feedbacking ACK and the method for feedbacking NACK according to the exemplary embodiment of the present invention grant the contention-free resources using the means for identifying the terminals upon the collision to quickly perform the retransmission, thereby reducing the latency. However, the method for feedbacking ACK may control the retransmission time of the contention-free resources and the method for feedbacking NACK may avoid the sudden increase in latency that is caused by the N_{TrueUeNum}−N_{EstimatedTxUeNum} terminals.

Therefore, the method for fast access in a communication system according to the exemplary embodiment of the present invention that performs the retransmission using the dedicated contention-free resources using the identification of the terminals upon the collision may include the method for selectively feedbacking ACK and NACK besides the method for feedbacking ACK and the method for feedbacking NACK.

The method for selectively feedbacking ACK and NACK according to the exemplary embodiment of the present invention basically follows the method for feedbacking NACK but follows the method for feedbacking ACK when it is difficult to feedback the NACK. That is, the base station always follows the method for feedbacking NACK but the method for selectively feedbacking ACK and NACK is a method appropriate for the case in which the base station is hard to grant the dedicated contention-free resources to all of the N_{EstimatedTxUeNum}−N_{RxDataNum} terminals, respectively, at the time t2, and therefore grants the dedicated contention-free resources only to the J (however, 0≦J<N_{EstimatedTxUeNum}−N_{RxDataNum}) terminals at the time t2 and grants the dedicated contention-free resources to the N_{EstimatedTxUeNum}−N_{RxDataNum}−J terminals after the time t2 to perform the retransmission using the contention-free resources after the time t3.

As such, the method for selectively feedbacking ACK and NACK has the increased complexity but may maximally take the advantage of the method for feedbacking ACK and NACK.

The HARQ combination by the method for selectively feedbacking ACK and NACK is the same as the method for feedbacking ACK and the method for feedbacking NACK. That is, the HARQ combination is granted the contention-free resources from the base station at the time t2 and thus is applied to the terminals performing the retransmission using the contention-free resources from the time t3. The terminals performing the retransmission using the contention-free resources from the time t3 are operated using the contention-free resources depending on the normal uplink HARQ operation from the retransmission, and therefore the base station combines the retransmission data other than the initial transmission for each terminal, thereby reducing the retransmission frequency.

Further, the HARQ combination by the method for selectively feedbacking ACK and NACK according to the exemplary embodiment of the present invention may also include the method for including and combining initial transmission data.

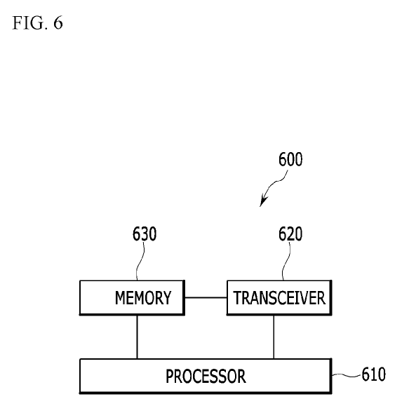

FIG. 6 is a diagram illustrating an apparatus for fast access according to an exemplary embodiment of the present invention.

Referring to FIG. 6, an apparatus 600 for fast access includes a processor 610, a transceiver 620, and a memory 630. The apparatus 600 for fast access may be implemented in the base station.

The processor 610 may be operated to implement the operations or the functions of the base station and the methods performed by the base station that are described with reference to FIGS. 1 to 5. The processor 610 may grant the shared resources by the SPS scheme and as described below, grant the contention-free resources for retransmission.

The transceiver 620 is connected to the processor 610 to transmit and receive a wireless signal to and from the terminal.

The memory 630 stores instructions which are performed by the processor 610 or loads instructions from a storage device (not illustrated) and temporarily stores the instructions and the processor 610 may execute the instructions which are stored or loaded in the memory 630. Further, the memory 630 may store the information associated with the operation of the processor 610.

The processor 610 and the memory 630 are connected to each other through a bus (not illustrated) and an input/output interface (not illustrated) may also be connected to the bus. In this case, the transceiver 620 is connected to the input/output interface and peripheral devices such as an input device, a display, a speaker, and a storage device may be connected to the input/output interface.

According to an exemplary embodiment of the present invention, the method of allowing several terminals to share resources and each terminal to independently transmit data depending on the distributed scheduling may provide various schemes of effectively managing the shared resources, thereby more increasing the resource efficiency upon the sharing of resources over the existing technology.

Further, compared to the existing contention-free retransmission methods, the retransmission time may be controlled and only the required terminal may perform the retransmission, such that the resources required for retransmission may be managed and the resource efficiency may be increased. Further, if the exemplary embodiment of the present invention is applied to LTE, LTE-A, or LTE-Pro system, the exemplary embodiment of the present invention may minimally change the standard of the existing LTE, LTE-A, or LTE-Pro system to support the HARQ operation, thereby minimally changing the standard and reducing the latency taken for the terminal performing the retransmission to successfully transmit data.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for fast access of a terminal in a base station, comprising:
granting the same shared resource to a plurality of terminals;
identifying a terminal transmitting uplink data in the same transmission time interval (TTI), when each of the plurality of terminals starts an initial transmission of the uplink data using the shared resource in the same TTI by distributed scheduling;
recognizing, by each of the plurality of terminals, not-acknowledgement (NACK) as a response signal to the uplink data if the number of terminals transmitting the uplink data estimated by the identification is equal to or more than 1; and
granting a contention-free resource as a retransmission resource to each of at least some terminals among the first number of terminals transmitting data that fail to receive among the identified terminals.

2. The method of claim 1, wherein:
the recognizing of the NACK as the response signal includes transmitting the NACK to the plurality of terminals.

3. The method of claim 1, wherein:
the recognizing of the NACK as the response signal includes transmitting neither ACK nor the NACK.

4. The method of claim 1, further comprising:
transmitting a new transmission resource grant signal used to inform the second number of terminals transmitting the uplink data that are successfully received among the identified terminals of the success of reception.

5. The method of claim 1, further comprising:
receiving retransmitted data using the same resource used for the initial transmission from the rest terminals other than some of the first number of terminals.
wherein the granting of the contention-free resource as the retransmission resource includes granting the contention-free resource to some of the first number of terminals, and

6. The method of claim 1, further comprising:
combining and decoding retransmitted uplink data when each of the at least some terminals performs a retransmission procedure of the uplink data at least twice using the contention-free resource.

7. The method of claim 1, further comprising:
receiving retransmitted data from each of the first number of terminals using the contention-free resource, and
combining the retransmitted data with initial transmission data received from each of the first number of terminals and decoding the combined data.

8. The method of claim 1, wherein:
the granting of the shared resource includes:
transmitting a period of the shared resource and an identifier used to grant the shared resource to the plurality of terminals before an activation time of the shared resource; and
determining a size and a position of the shared resource at the activation time and transmitting the shared resource to the plurality of terminals, and
the identifier used to grant the shared resource is differently assigned to each terminal within a cell.

9. The method of claim 8, wherein:
the granting of the shared resource further includes determining a modulation and coding scheme (MSC) of the plurality of terminals so that at least some of the plurality of terminals have different MCSs.

10. The method of claim 8, further comprising:
instructing deactivation of the shared resource to at least one of the plurality of terminals,
wherein the shared resource is not granted to other terminals until the number of terminals using the shared resource is 0.

11. The method of claim 8, further comprising:
instructing deactivation of the shared resource to at least one terminal when a deactivation signal indicating a deactivation request is successfully received once from the at least one of the plurality of terminals through the shared resource.

12. The method of claim 11, wherein:
the deactivation signal includes a zero service data unit (SDU) or a zero buffer status report (BSR).

13. A method for fast access of a terminal in a base station, comprising:
granting the same shared resource to a plurality of terminals;
identifying a terminal transmitting uplink data in the same transmission time interval (TTI), when each of the plurality of terminals starts an initial transmission of the uplink data using the shared resource in the same TTI by distributed scheduling;
transmitting acknowledgement (ACK) as a response signal to the uplink data to the plurality of terminals if the number of terminals transmitting the uplink data estimated by the identification is equal to or more than 1; and
granting a contention-free resource as a retransmission resource to each of at least some terminals among the first number of terminals transmitting data that fail to receive among the identified terminals.

14. The method of claim 13, wherein:
the granting of the contention-free resource includes granting the contention-free resource to the first number of terminals at the same time or different time.

15. The method of claim 13, further comprising:
receiving retransmitted data from each of the first number of terminals using the contention-free resource, and
combining the retransmitted data with initial transmission data received from each of the first number of terminals and decoding the combined data.

16. The method of claim 13, further comprising:
combining and decoding retransmitted uplink data when each of the at least some terminals performs a retransmission procedure of the uplink data at least twice using the contention-free resource.

17. An apparatus for fast access of a terminal in a base station, comprising:
a transceiver communicating with a plurality of terminals to which the same shared resource is granted; and
a processor identifying a terminal transmitting uplink data in the same transmission time interval (TTI) when each of the plurality of terminals starts an initial transmission of the uplink data using the shared resource in the same TTI by distributed scheduling, and allowing the plurality of terminals to recognize not-acknowledgement (NACK) or acknowledgement (ACK) as a response signal to the uplink data if the number of terminals transmitting the uplink data estimated by the identification is equal to or more than 1, and granting a contention-free resource as a retransmission resource to each of at least some terminals among the first number of terminals transmitting uplink data that fail to receive among the identified terminals.

18. The apparatus of claim 17, wherein:
the processor generates the ACK or the NACK as the response signal to the initial transmission if the number of terminals is equal to or more than 1 and transmits the ACK or the NACK to the plurality of terminals through the transceiver.

19. The apparatus of claim 17, wherein:
the processor transmits neither the ACK nor the NACK, and
the plurality of terminals recognize the NACK if the response signal is not received.

20. The apparatus of claim 17, wherein:
the processor grants a new transmission resource used to inform each of the second number of terminals transmitting uplink data that are successfully received among the identified terminals of the success of reception and transmits a new transmission resource grant signal through the transceiver.
